(19) United States
(12) Patent Application Publication
(10) Pub. No.: US 2011/0113221 A1
(43) Pub. Date: May 12, 2011

(54) Data Sharing in Chip Multi-Processor Systems

(75) Inventor: Andras Vajda, Masala (FI)

(73) Assignee: TELEFONAKTIEBOLAGET L M ERICSSON (PUBL), Stockholm (SE)

(21) Appl. No.: 13/000,741

(22) PCT Filed: Aug. 18, 2008
(86) PCT No.: PCT/IB2008/002160

§ 371 Date: Dec. 22, 2010

(51) Int. Cl. G06F 15/76; G06F 9/02

(52) U.S. Cl. 712/30; 712/E09.002

(57) ABSTRACT

System, computer readable medium and method for providing transparent access to shared data (16) in a chip multi-processor system (900), without using locks or transactional memory constructs, where a first set of processing entities (12) communicate with a second set of processing entities (14) via a task queue (20) for executing a code that necessitates access to the shared data (16). The method includes receiving at the second set of processing entities (14) a task (21) from the task queue (20), the task (21) including a request from the first set of processing entities (12) for accessing the shared data (16); establishing a communication link (15) between the second set of processing entities (14) and the shared data (16) such that requests for accessing the shared data (16) from the first set of processing entities (12) are routed through the communication link (15) to the shared data (16); transparently migrating the execution of the code from the first set of processing entities (12) to at least one processing entity (14) of the second set of processing entities (14), to execute the task (21) by accessing the shared data (16) via the communication link (15); and sending a completion message from the at least one processing entity (14) of the second set of processing entities (14) to the first set of processing entities (12) indicating a status of the executed task.

### TECHNICAL FIELD

The present invention generally relates to chip multi-processor systems, software and methods and, more particularly, to mechanisms and techniques for reliable data sharing.

### BACKGROUND

During the past years, the computational systems (personal computers, devices configured to display content, clusters, etc.) are using chip multi-processor systems in an effort to increase the efficiency and speed of the device and also to offer to the user an enhanced media based experience, for example, games, movies, etc. However, there is a general problem affecting the chip multi-processor systems. It is known that each individual processor of the system may try to access the same data (shared data) from a same location (of a memory) at the same time with other individual processors of the system, which is know as the share state problem. Thus, for example, if two different processors of the system are allowed to access the same data at the same time, the consistency of that data may be compromised, which results in an unreliable device.

Securing (shared) data consistency in a case of concurrent access by multiple processing elements or threads to the same piece of information stored, for example, in a volatile memory (RAM), is thus a problem for the chip multi-processor systems.

There has been intensive work addressing the problem of shared state (or shared memory) in chip multi-processor systems, especially in chip multiprocessors (CMP). There are two approaches to mitigate the problem of accessing the shared state, (i) using locks and (ii) using hardware or software transactional memory. Both concepts are briefly discussed next. Locks are resources that may be owned by only one processing instance (processor or thread). If a processing instance acquires the ownership of a lock, it is guaranteed exclusive access to the underlying resources (such as data). In other words, a lock locks out the access of all the other processors to the shared data except the processor owning the lock. In the software transactional memory (TM) approach, concurrent access to data is allowed. However, in case a conflict arises between first and second accessing entities that try to access the same data at the same time, the first accessing entity is stopped and all the changes performed by that entity are rolled back to a safe state. Then, only the second accessing entity is allowed to act on the shared data. After the second accessing entity has finishing acting on the shared data, the first accessing entity is allowed to act on the shared data.

However, both of these approaches have a number of limitations that are discussed next. With regard to locks, they are non-composable, i.e., two pieces of correct program code, when combined, may not perform correctly, leading to hard-to-detect deadlock or live-lock situations. The transactional memory approach, while composable, has a large processing overhead, usually requiring hardware support. In addition, the transactional memory approach is not scalable, i.e., an expansion of the chip multi-processor system (adding more processors to the existing system) is not easily implemented. Thus, the chip multi-processor system may perform increasingly inefficient in case that the number of processing elements trying to access the same data is increased.

In addition, neither locks nor TM are predictable and deterministic, i.e., it is difficult, and in some cases impossible, to calculate a reliable upper-bound for an execution time required by the accessing entities. This behavior is not suitable for at least, for example, the real-time applications.

Accordingly, it would be desirable to provide devices, systems and methods for sharing data that avoid the afore-described problems and drawbacks.

### SUMMARY

According to one exemplary embodiment, there is a method for providing transparent access to shared data in a chip multi-processor system, without using locks or transactional memory constructs, where a first set of processing entities communicate with a second set of processing entities via a task queue for executing a code that necessitates access to the shared data. The method includes receiving at the second set of processing entities a task from the task queue, the task including a request from the first set of processing entities for accessing the shared data; establishing a communication link between the second set of processing entities and the shared data such that requests for accessing the shared data from the first set of processing entities are routed through the communication link to the shared data; transparently migrating the execution of the code from the first set of processing entities to at least one processing entity of the second set of processing entities, to execute the task by accessing the shared data via the communication link; and sending a completion message from the at least one processing entity of the second set of processing entities to the first set of processing entities indicating a status of the executed task.

According to another exemplary embodiment, there is a chip multi-processor system for providing access of a first set of processing entities to shared data without using locks or transactional memory constructs. The system includes a second set of processing entities configured to receive a task from a task queue, the task including a request from the first set of processing entities for accessing the shared data; the shared data being connected via a communication link to the second set of processing entities such that requests for accessing the shared data from a code executed on the first set of processing entities are routed through the communication link to the shared data; and at least one processing entity of the second set of processing entities being configured to execute a part of the code from the first set of processing entities to access the shared data via the communication link such that the execution of the code transparently migrates from the first set of processing entities to the at least one processing entity, and to send a completion message to the first set of processing entities indicating a status of the executed task.

According to another exemplary embodiment, there is method for facilitating safe access to shared data in a chip multi-processor system, where a first set of processing entities communicate with a second set of processing entities via a task queue for accessing the shared data, which is owned by the second set of processing entities, the communication being assisted by a runtime system. The method includes invoking a first primitive of the runtime system when access to at least one shared data area of the shared data is requested by at least one first processing entity of the first set of processing entities, the at least one first processing entity executing a code that includes a critical section that necessitates the access to the shared data area; blocking an activity of the at least one first processing entity, when an indicator is detected by the first primitive in the request, until the access to the shared data area is completed; selecting from the second set of processing entities at least one second processing entity via a second primitive of the runtime system; dispatching via a third primitive the request to the selected at least one second processing entity of the second set of processing entities while the code is executed on the at least one first processing entity; and suspending, by a forth primitive of the runtime system, the execution of the code on the at least one first processing identity when a result of the execution of the critical section is needed by the code.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a chip multi-processor system according to an exemplary embodiment;

FIG. 2 is a schematic diagram showing interactions of various entities of the chip multi-processor system according to an exemplary embodiment;

FIG. 3 is a flow chart illustrating various steps performed for sharing data according to an exemplary embodiment;

FIG. 4 is a schematic diagram of an operating system for accessing Netware data;

FIG. 5 is a flow chart illustrating various steps performed by a user performing entity according to an exemplary embodiment;

FIG. 6 is a flow chart illustrating various steps performed by a data owner processing entity according to an exemplary embodiment;

FIG. 7 is a flow chart illustrating steps performed by a plurality of processing entities according to an exemplary embodiment;

FIG. 8 is a flow chart illustrating steps performed by a runtime system according to an exemplary embodiment; and

FIG. 9 is a schematic diagram of a processing entity according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following exemplary embodiments are discussed, for simplicity, with regard to the terminology and structure of a chip multi-processor system. However, the embodiments to be discussed next are not limited to these systems but may be applied to other existing systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment, to mitigate the problems noted in the Background section, a configuration of a chip multi-processor system that will be discussed next addresses all those issues, leveraging on new possibilities provided by CMP systems. Furthermore, the configuration of the chip multi-processor system to be discussed may lead to an improvement in the utilization of the memory bandwidth to the CMP, hence enhancing further the usability of this system. One or more of the systems of the exemplary embodiments may provide a predictable, scalable, composable and simple approach to handling shared states in CMPs.

Before discussing more specifically some of the exemplary embodiments, it is noted that one way to avoid shared state access conflicts may be to enforce that there is only one set of processing entities, and the same set of processing entities, having access to the shared state (i.e., in real terms, there is no shared state from the point of view of the one set of processing entities that own the shared data as no other set of processing entities have direct access to the shared data).

Also, it is noted that in future CMPs, which may include several hundreds cores, memory bandwidth and on-chip cache capacity will be likely the bottlenecks of processing, while sheer processing power is likely to be a plentiful resource where limited waste is acceptable

Based in part on these observations, according to an exemplary embodiment, there is a system in which access to the shared data (e.g., shared memory space) is always performed by one predetermined set (and always the same) of processing entities (cores, processors, etc.), which may perform the requested operations according to a configurable policy. This policy may be, for example, a time-based order or some other mechanism (such as priorities) for allowing that plural tasks stored in a task queue are processed according to their urgency or another suitable criterion. A task may include any number of actions (e.g., a piece of program code) and the task may access any number of shared data instances.

This way, a strict serialization of accesses to the shared data may be achieved with only hardware constructs (i.e., no locks or TM), and also, it is guaranteed that there are no race conditions when using the hardware constructs (i.e., predetermined processing entities are configured to own the shared data). The system of this exemplary embodiment may achieve the earliest possible execution of the access to the shared data that complies with the set policy. In addition, this system may be scaled arbitrarily with regards to the number of concurrent accesses to a shared state. Another characteristic of this system is that the access to the shared data may be performed in the context of the program requiring the access (first set of processing entities), hence securing, at the application level, a transparent solution for accessing shared memory locations. More specifically, from the application point of view, it may be completely invisible that the access to the shared data, i.e., the execution of the code performing the access, is performed on a different core/processing element. This means that the critical section may be written so that it has access to all the local data of the calling thread, i.e., it is performed in the same context. In other words, the execution of the code associated with the application is transparently migrated from one processing element to another processing element when the critical section of the code needs access to the shared data.

Other characteristics of one or more of the exemplary embodiments to be discussed are related to enforcing data locality, i.e., securing that only a limited number of accessing entities (one or more) but the same processing entities (processor(s) or thread(s)) have access to the shared data area during data processing. In addition, one or more of the embodiments to be discussed may float the execution of threads accessing shared data to the processing entities that own the data (second set of processing entities).

Thus, when a processing entity (first processing entity) needs access to one or more areas of the shared data, the processing entity may dispatch a request, containing the updates to be performed, to the data-owner processing entities (second processing entity), which may be a thread, processor, core of a processor, etc., and the requesting processing entity may enter a wait state, immediately or at a later moment, until the updates to be performed by the data-owner processing entities are terminated. The updated are physically performed, in the context of the original processing entity, by the data owner (data-owner processing entities). This way, accesses to shared data areas are implicitly serialized, and the updates are happening in the shortest possible time, without the need to use locks or try-fail-retry mechanisms. In addition, it is noted that this novel configuration allows for parallel processing, i.e., first processing entity performs the code while the second processing entity (that owns part of the shared data) simultaneously executes the critical section of the code

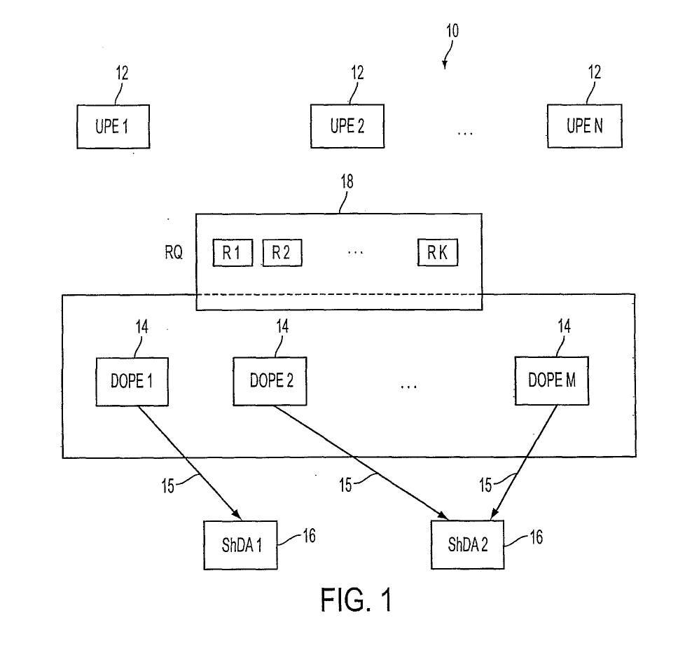

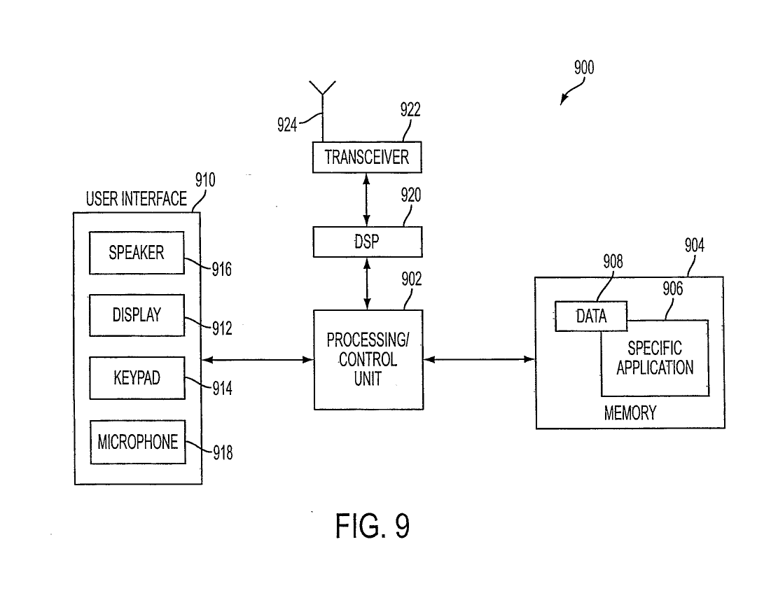

As shown in FIG. 1, according to an exemplary embodiment, a chip multi-processor system 10 includes User Processing Entities (UPE 1 to n, first set of processing entities) 12, which may be processing entities (processors, cores, or threads) executing applications that require access to shared data, which is accessed concurrently by other processing entities 12 as well. The system 10 may also include Data Owner Processing Entity (DOPE 1 to m, second set of processing entities) 14, which may be processing entities (processors, cores or threads) owning and having exclusive access to certain shared data. Optionally, the system 10 may include one or more Shared Data Areas (ShDA) 16, which may part of one or more shared data, i.e., a memory or a disk area to which access is required concurrently by more than one UPE 12. The system 10 also may include a Request Queue (RQ, or task queue) 18, which may include one or more access requests R1 to Rk from UPE 12 to ShDA 16. The requests are outstanding requests from UPE 12 to ShDAs 16. An outstanding request may identify, according to an exemplary embodiment, the ShDA that will be accessed, an identification of the program code that may be executed (e.g., a function name), as well as the identity of the UPE issuing the request, i.e., the context in which the request shall be executed. The DOPEs 14 are linked (communication links) to the ShDAs 16 such that requests from UPEs for accessing ShDAs 16 are routed through the communication links 15. The communication link 15 may be considered a direct communication link between DOPE and ShDA because no UPE is present between these two elements. In one exemplary embodiment, each DOPE 14 is directly linked to a corresponding ShDA 16, with more than one DOPE 16 being connected to a same ShDA 16. These possible elements of the chip multi-processor system are described in more details later, with regard to a possible hardware implementation, as shown in FIG. 9.

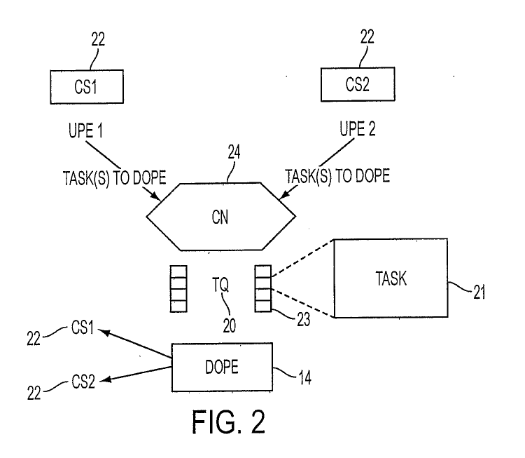

The above noted elements of system 10 are discussed now with regard to FIG. 2, which also shows a functional interaction between these elements. The ShDAs 16, which may be a memory location that is accessed by more than one processing entity, may need to be identified by the DOPE 14. One way for providing this identification is to use a Shared Data Area Id (SDAI), which is an identifier (e.g., an integer) uniquely identifying the ShDA 16.

A Processing Entity (PE, either UPE 12 or DOPE 14) may be an entity, such as a processor, core or thread, that executes a software program. A Task Queue (TQ, which may be identical to RQ 18 shown in FIG. 1) 20 is configured to store various tasks 21. In one exemplary embodiment, the task queue 20 stores requests (tasks 21) to execute critical sections, which are discussed later. Each task 21 may include an identification of the calling thread and PE, a list of SDAIs that will be accessed, a location of a critical section that needs to be executed, etc. In one embodiment, there may be multiple task queues per DOPE, one for each priority level 23, as shown for example in FIG. 2. FIG. 2 shows that multiple task queues may be stored according to a priority level 23, to be executed by DOPE in an order dependent on the highest priority level. The highest priority level may be determined by a parameter, which is for example, an integer number.

A Critical Section (CS) 22 may include code segments that provide/require access to the ShDAs 16. The CS 22 may be characterized by a name, a unique identifier (used in a case that several instances of the critical sections are executed at the same time), an optional priority level, a list of SDAIs (SDAIi1, SDAIi2, . . . , SDAIin) that the CS accesses, and a blocking indicator. The blocking indicator may indicate whether the critical sections' execution is blocking or non-blocking, i.e., the current thread may or may not continue to execute the code as will be explained later.

Another feature, which may be used in the following exemplary embodiments to explain how the chip multi-processor system is configured to read the shared data, is the Critical Section Group (CS-G). CS-G is a group of CS with the property that any ShDA used by any of the CS belonging to the group is used by at least one other CS. In other words, CSs in a group are depending on a shared set of ShDA and thus, the CSs may have an execution order dependency on each other.

In one exemplary embodiment, the code segments of the critical sections that require access to ShDAs are marked explicitly. For example, the primitive below may mark this critical section:

CRITICAL_SECTION (name, id, priority_level, blocking_indicator,
list_of_SDAI)
{
// code
};

This code segment may be part of CS1 or CS2 shown in FIG. 2. The CS1 and CS2 may be part of a code that is executed by an UPE.

In addition, in case that the critical section is non-blocking, there may be a need for a synchronization primitive in the runtime system, i.e., a primitive that informs the program (code) including the critical section to wait for the critical section to finish. One such example may be the following primitive:

SYNCH ({CS_Name, CS_Id}, . . . ).

By declaring a SDAI as being used in a critical section does not automatically mean any action on those specific shared resources. Actually, according to an exemplary embodiment, the configuration does not even require an explicit mapping of the SDAI to the ShDAs, though such approach would allow cache usage optimizations, as discussed later.

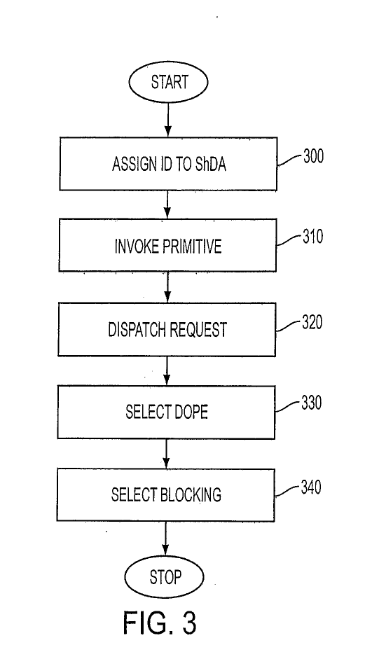

According to an exemplary embodiment, FIG. 3 shows the steps of a method that may be followed for performing data sharing in the chip multi-processor system 10, from the runtime system point of view. Some of the steps are optional. In step 300, each shared data area is assigned a unique identifier (this step may be performed in the design phase of the system).

In step 310, a primitive of the runtime system (the runtime system is software that provides services for a running program but is itself not necessarily considered to be part of the operating system) is invoked when one or several of the ShDA are to be accessed or the beginning of a critical section is reached within a code that is run on one of the UPEs 12.

The underlying run-time system notices this point in the execution of the code either through hardware or through software generated by a compiler. At this point, the run-time system may block the original code (which includes the critical section) or may let the original code run in parallel with the critical section, depending on how the critical section was defined. However, in both cases, the runtime system may run the step 320 and 330 in parallel with the UPE running the original code.

The invocation step 310 may include the identities of all ShDA that will be accessed as well as the identification (e.g., the address) of the program code that will perform the access. Another possibility is to explicitly mark the start of such critical sections in the code. In this case, the compiler and/or the runtime system may perform execution order re-arrangements so that the execution of the access to ShDA is performed as soon as possible.

The invocation of the runtime primitive may be blocking or non-blocking, as discussed above. A blocking primitive suspends the current processing entity (the execution of the original code) until the access to ShDA is completed. A non-blocking primitive allows the processing entity to continue executing the code unconditionally (e.g., in case the access is about updating a global counter) or until the primitive needs to synchronize with the access entity. Thus, this approach covers the possibility of splitting the execution of the application thread, since the critical section will execute in the same context as the original PE was executing the original code.

In step 320, the runtime system may generate another primitive that dispatches the request for accessing the shared data from the UPE to one of the DOPEs for effectively accessing the shared data. One possible algorithm for selecting which DOPE processes the request is described below with regard to step 330. In certain implementations, the DOPE may inherit the execution context (e.g., access to local/private data) of the invoking UPE. Thus, from the application point of view, it may be completely invisible that the critical section is executed on another PE (DOPE). Also, from the application point of view, it may be advantageous that (i) the application is executed within the same context, and (ii) the access to the shared data does not collide with other concurrent accesses (i.e., the application is executed in a consistent way).

In step 330, the DOPE may be selected based on usage of (i) locks among various DOPEs, i.e., any DOPE may run any request and thus there may be a lock for each ShDA identity and ownership of all may be done as an atomic operation; (ii) TM techniques; and/or (iii) distribution of requests to DOPEs based on groups of ShDA, with the characteristic that no two groups of ShDA contain the same ShDA. However, it is noted that the locks or TM are used to select a DOPE and not to access the shared data. As discussed above, no locks or TM are used for accessing the shared data in this exemplary embodiment.

In step 340, the runtime system may provide a primitive that may be invoked to block the execution of the original code in the UPE and wait for the request dispatched in step 320 to be processed. This step may be needed in case the critical section is marked as non-blocking but the UPE still needs, at a later stage, to wait for the execution of the request to complete.

For illustrative purposes only, the following example is provided for a better understanding of the method illustrated in FIG. 3. Suppose that the code executed by UPE includes the following critical section that includes a non-blocking parameter, i.e., the critical section would be executed by the DOPE (migrates to the DOPE) while the code continues to be executed by the UPE:

CRITICAL_SECTION (CSNAME, ..., non-blocking)
{
This code is executed on the DOPE
}
// The original code continues to be executed on UPE
.....

// here the original code executed on UPE needs the result from the critical section, thus the following construct provided by the runtime system is executed:

SYNCH(CSNAME)

// the run-time system will only return from the SYNCH statement when the execution of the critical section was completed on one of the DOPEs.

According to another exemplary embodiment, a chip multi-processor system is configured to share data in a novel way, as discussed next. In this exemplary embodiment, the available PE resources may be grouped in two classes: (i) UPE (first set of processing entities), running user applications that do not require access to shared data areas (ShDA), and (ii) DOPE (second set of processing entities), dedicated to executing critical section codes and having access to ShDA instances and in fact owning the shared data. According to this exemplary embodiment, no locks or TM are used to enforce that the DOPEs act on the ShDAs while the UPEs are not allowed to act directly on the ShDAs. The lack of locks and TM is compensated by the usage of hardware constructs, i.e., the hardware configuration of the system is such that the sequential access to ShDAs is achieved based on the arrangement of DOPEs to access the ShDAs. The lack of locks and TM provides this embodiment with the advantage that all problems associated with locks and TM are eliminated.

In this exemplary embodiment, the number of DOPEs may be from one to n, where n is a positive integer. The UPEs are not allowed to access the shared data, i.e., any need to access the shared data is transmitted from the UPEs to corresponding DOPEs and only the predetermined DOPE may access the shared data based on the communication links existent between the DOPEs and ShDAs. Thus, the UPEs and DOPEs are configured to act together such that the UPEs do not directly access the shared data, preventing corruption of this data. The number of DOPE instances may be arbitrary, but there may be one instance for each critical section group required by the application under execution.

It is noted, for this exemplary embodiment, that a user application is different from a runtime application in the sense that the runtime application is concerned about the operation system (OS) of the system while the user application is concerned about a particular application that is running on the system. Also, it is noted that the handling and management of shared data with respect to the operation system and with respect to the user applications are different and distinct from each other.

It is the understanding of the inventor that handling user applications (in view of accessing shared data) is treated differently in the industry, at the time of this invention, from the handling of shared data related to the operating system. In other words, the industry does not provide lock-free and TM-free solutions for shared data handling as discussed above in some exemplary embodiments. In this regard, it is known that, within a uniprocessing environment, NetWare data (which is a network operating system developed by Novell, Inc., Waltham, Mass. 02451, USA) does not need to be protected against corruption because there is no possibility that more than one process will access the data at a given time. However, in a multiprocessing environment, multiple threads running on multiple processors need to access the unprotected NetWare data. If multiple threads were to access the same data at the same time, the data could become corrupted.

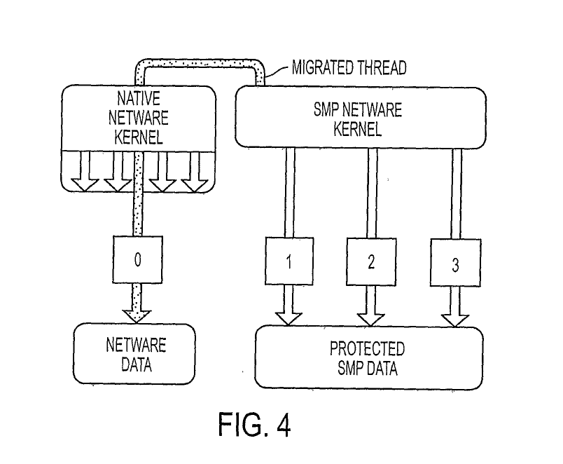

To avoid corrupting the unprotected NetWare data, NetWare Symmetric MultiProcessing (SMP) uses a mechanism called thread migration. Thread migration forces all threads that need access to NetWare data to go through a native NetWare kernel. The native NetWare kernel can process only one thread at a time (because it has access to only one processor, processor 0 in FIG. 4). Therefore, no multiple threads are accessing the NetWare data simultaneously. The native NetWare kernel acts in a similar way as a gateway that allows only one thread at a time to access the NetWare data. FIG. 4 shows the SMP NetWare kernel migrating a thread to the native NetWare kernel so the thread can access NetWare data. However, this system is designed for a network operating system and achieves the goal of maintaining the Netware data free of corruption by having only one processor (processor 0) that can access this data. No similar solutions are available for data that is shared between application threads. To the contrary, the exemplary embodiments discussed herein provide a consistent approach to accessing shared data by any application without using locks or TM.

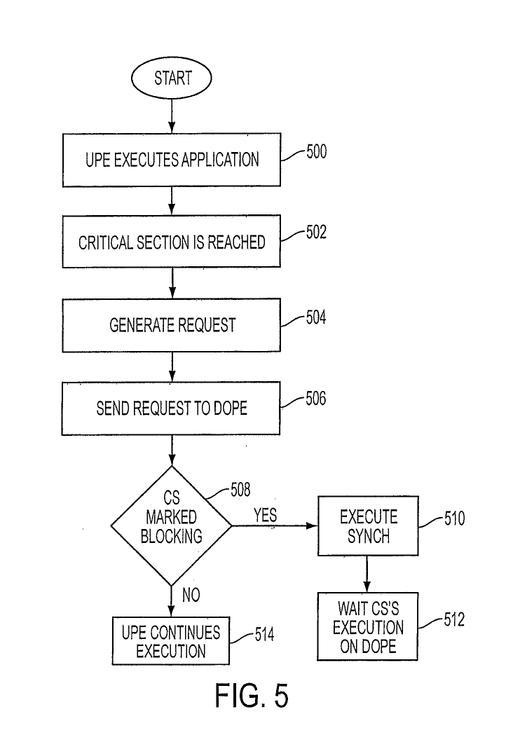

Returning to the exemplary embodiment, the execution of user applications on the UPE is discussed next with regard to FIG. 5. In step 500, UPEs execute user applications. When the start of a critical section is reached in step 502, the execution of the user application may be halted. At this point, the UPE may generate in step 504 a message, which may be sent as a request in step 506, to the task queue of the DOPE(s) dedicated to the CS-G to which the current critical section belongs. After this message is generated and dispatched in steps 504 and 506, for example, over the on-chip communication network 24 shown in FIG. 2, the UPE has one of the two following choices:

(i) if step 508 determines that the critical section is marked as blocking, the UPE may execute a SYNCH construct in step 510 and wait in step 512 for the critical section's execution to complete on the DOPE(s), or

(ii) if step 508 determines that the critical section is marked as non-blocking, the UPE may continue the execution of the program in step 514, right after the detection of the critical section in step 502 while the critical section is executed in parallel on DOPE.

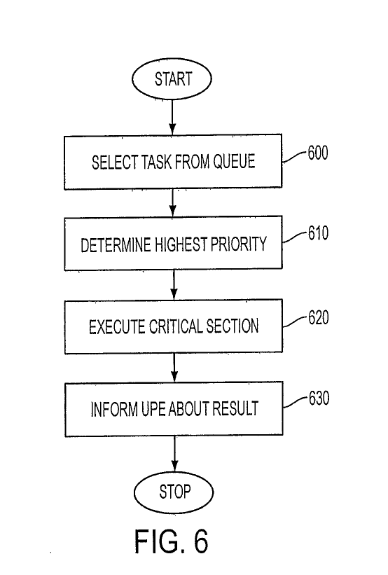

The execution of the application on the DOPE side is discussed next. In order to prevent the occurrence of a dead-lock, there may be exactly one DOPE for each critical section group, and there may be a message queue per priority level for each DOPE. The execution on DOPE, according to an exemplary embodiment, is as shown in FIG. 6. In step 600, the DOPE selects a next task from the queue. The selected task is determined based on the highest priority request in the task, which is verified in step 610. If no task is found in steps 600 and 610, the DOPE idles until a task with these characteristics becomes available. Once the task is selected, the DOPE executes the critical section in step 620, i.e., accesses the shared data area and performs the operation requested by the UPE and expressed in the task. Upon completion of the task, the DOPE informs UPE in step 630 about the result of the operation, i.e., successful completion of the operation or not. The case of nested critical sections is discussed later.

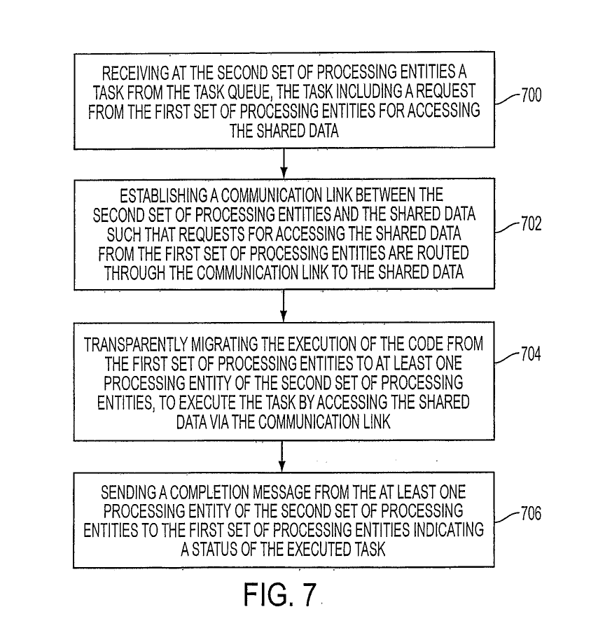

According to an exemplary embodiment, there is a method, as shown in FIG. 7, for providing transparent access to shared data in a chip multi-processor system, without using locks or transactional memory constructs, where a first set of processing entities communicate with a second set of processing entities via a task queue for executing a code that necessitates access to the shared data. The method includes a step 700 of receiving at the second set of processing entities a task from the task queue, the task including a request from the first set of processing entities for accessing the shared data, a step 702 of establishing a communication link between the second set of processing entities and the shared data such that requests for accessing the shared data from the first set of processing entities are routed through the communication link to the shared data, a step 704 of transparently migrating the execution of the code from the first set of processing entities to at least one processing entity of the second set of processing entities, to execute the task by accessing the shared data via the communication link, and a step 706 of sending a completion message from the at least one processing entity of the second set of processing entities to the first set of processing entities indicating a status of the executed task.

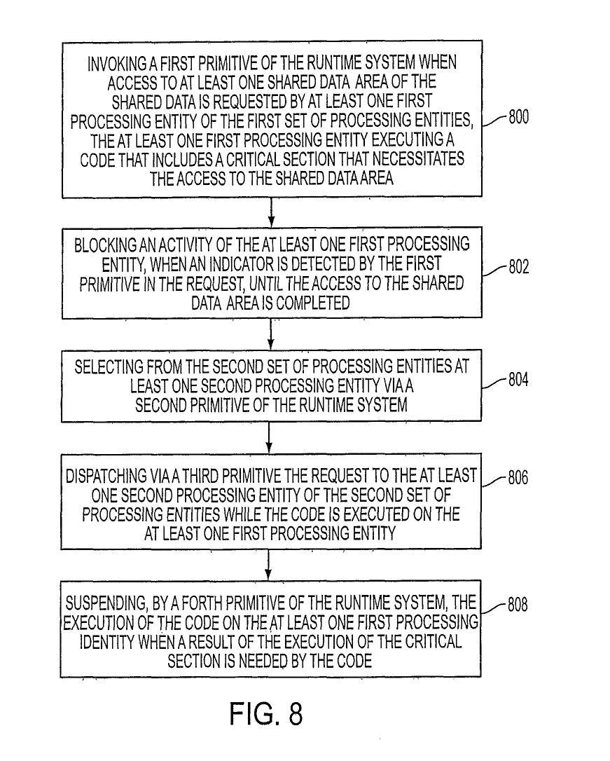

According to another exemplary embodiment, the runtime system may provide various primitives for supporting the access to shared data. FIG. 8 shows in this respect steps to be performed by a method to be implemented in the runtime system. The method may facilitate safe access to shared data in a chip multi-processor system, where a first set of processing entities communicate with a second set of processing entities via a task queue for accessing the shared data, which is owned by the second set of processing entities, the communication being assisted by a runtime system. The method includes a step 800 of invoking a first primitive of the runtime system when access to at least one shared data area of the shared data is requested by at least one first processing entity of the first set of processing entities, the at least one first processing entity executing a code that includes a critical section that necessitates the access to the shared data area, a step 802 of blocking an activity of the at least one first processing entity, when an indicator is detected by the first primitive in the request, until the access to the shared data area is completed, a step 804 of selecting from the second set of processing entities at least one second processing entity via a second primitive of the runtime system, a step 806 of dispatching via a third primitive the request to the at least one second processing entity of the second set of processing entities while the code is executed on the at least one first processing entity, and a step 808 of suspending, by a forth primitive of the runtime system, the execution of the code on the at least one first processing identity when a result of the execution of the critical section is needed by the code. Optionally, the method may include a step of executing in parallel the code on the at least one first processing entity and the critical section of the code on the at least one second processing entity that owns part of the shared data.

Various optional steps may be performed with this method. For example, it may be added an HW mechanism, such as a processor instruction or set of instructions which would trigger automatic generation of dispatch message to the DOPE as well as instruction(s) that would trigger transferring of thread context from one core to another. In another words, it may be possible to provide a hardware mechanism that includes generating at least one processor instruction that automatically dispatches the task to the second set of processing entities. In addition, a step of transferring a thread context from the first set of processing entities to the second set of processing entities based on the hardware mechanism may be performed.

According to an exemplary embodiment, the DOPE may execute the critical section code in the context of the UPE thread that issued the request, hence allowing access to thread local memory. In case of a non-blocking invocation of the critical section, precaution may be taken to avoid concurrent accesses to thread local resources (i.e., concurrently accesses from the critical section and the main thread executing on the UPE). One way to mitigate this problem is to make all critical sections functions with no access to global memory areas (other than the ShDA). However, the code on application level may still be designed and written as if it would be a sequential, single-threaded code.

According to an exemplary embodiment, there may be a problem if nested critical sections are present inside other critical sections. In other words, it is possible that a critical section invokes another critical section. In this case, there are at least two options to deal with this problem. According to one approach, if the nested critical section is a member of the same CS-G, the nested critical section may be executed immediately. According to another approach, the task of executing the nested critical section is dispatched to the corresponding DOPE task queue and may be executed later, after which the execution of the nesting critical section resumes.

The execution of tasks discussed about with regard to UPE and DOPE may be implemented in software, hardware or a combination thereof, as will be discussed next.

In a software implementation, with no compiler support, the services for off-loading the critical-section execution to specialized processing elements may be part of a runtime system library. For example, CRITICAL_SECTION and SYNCH constructs may be translated to blocking or non-blocking library calls and the runtime system may generate, in response to these constructs, corresponding messages to the DOPE(s). The runtime system may dynamically detect (or be explicitly informed about) the CS groups to which various critical sections belong.

In order to allow access to thread-local data on UPEs, all threads, whether executing on UPE or DOPE, may be part of the same process, i.e., shared memory construct. In general OS theory, only threads belonging to the same process can share the memory.

Potential improvements of this exemplary embodiment may include pre-declaring the messages that are sent to and from DOPE(s), and thus the sending of these messages may use less cycles; and coding the CRITICAL_SECTION and SYNCH may be in-lined, e.g., instead of executing a function call, the whole content of the function is copied to the place where the function is called resulting in a longer but faster code, to enhance performance.

In a software or hardware realization with compiler support, the compiler may perform a re-arrangement of the code so that the tasks are sent to the DOPE as soon as possible while the UPE executes other code, hence reducing the latency of the system. Also, dispatching of the tasks may be reduced in this exemplary embodiment to just a few machine instructions by, for example, allocating a unique identification to each possible critical section invocation and dispatching only that singe value over the on-chip network. The compiler and a linker (which is a program that takes one or more objects generated by compilers and assembles them into a single executable program) may also determine statically the critical section groups and generate a target code accordingly.

Further improvements of this exemplary embodiment may be achieved by hardware support for pre-firing tasks, for example, in an out-of-order execution fashion. Also, locking critical section code and shared resources (memory) to the local cache of the DOPE(s) may further improve performance by mitigating memory access latencies and reducing the need for memory bandwidth.

One or more advantages of the exemplary embodiments described above are discussed next in comparison to the conventional locks and TM. One advantage of the exemplary embodiments is that a mechanism for implementing shared memory constructs in a parallel, many-core, system on chip environment is achieved without the need to rely on locks or transactional memory solutions. This advantage is achieved by dedicating certain hardware resources (for example processing entities) to be exclusive data owners (DOPEs) of the shared data and by implementing a mechanism through which execution of an application thread may be moved between processing entities (which may be implemented either in software or a combination of hardware and software), i.e., from UPE to DOPE.

Another advantage is the execution of the application code both on the UPE and DOPE, thus achieving more parallelism than existing systems. This advantage is amplified when the UPE performs the offloading earlier than indicated in the source code, when the UPE detects that the execution of the code may safely be performed. Such advantages are not possible with TM or lock based approaches due to the use of only one processor core in these techniques.

Another advantage is the constant overhead for the UPE in case there are no data races, equal to the cost of passing a message from PE to another one. This advantage may be hardware architecture dependent. However, the cost of this feature is less or equal to the cost of acquiring a number of locks or initializing transactions.

Still another advantage is enforcing the data locality (at the DOPEs that own the shared data), which allows ShDA to be stored in a local cache, near the DOPE, thus reducing memory access penalties.

Another advantage is the composability of the system, i.e., the correct execution of the codes in all cases, irrespective of the number of processing elements (cores). In this regard, it is known that two pieces of correct program code using locks, when combined, may not perform correctly, leading to hard-to-detect deadlock or live-lock situations.

According to another advantage, the configuration of the chip multi-processors is used to boost performance (execution speed) of the system, for example, by offloading the UPE in case the UPE does not need the results of the access to the ShDA.

The solutions provided by the above exemplary embodiments are suitable for real-time applications. Thus, these solutions may make the real-time applications predictable in terms of delay, latency and processing overhead. Also, the provided solutions are scalable, i.e., they only depend on the amount of ShDA. In other words, with the amount of ShDA fixed, it guarantees the earliest possible execution of access to ShDA, immediately after all previously triggered competing accesses are completed, contrary to the dead-lock and infinite retries cases of locking or TM solutions. Thus, there are no wasted executions of the program (as in TM case) and no dead-lock situations.

These advantages may be realized by hardware implementations such as automatic prediction and execution of offloading to DOPEs.

For purposes of illustration and not of limitation, an example of a representative chip multi-processor system capable of carrying out operations in accordance with the exemplary embodiments is illustrated in FIG. 9. It should be recognized, however, that the principles of the present exemplary embodiments are equally applicable to standard chip multi-processor systems.

The exemplary chip multi-processor system arrangement 900 may include a processing/control unit 902, such as a microprocessor, reduced instruction set computer (RISC), or other central processing module. The processing unit 902 may include a set of processors. For example, the processing unit 902 may include a master processor and associated slave processors coupled to communicate with the master processor.

The processing unit 902 may control the basic functions of the system 900, as dictated by programs available in the storage/memory 904. Thus, the processing unit 902 may execute the functions described in FIGS. 7 and 8. More particularly, the storage/memory 904 may include an operating system and program modules for carrying out functions and applications on the system. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the system 900 via data signals, such as being downloaded electronically via a network, such as the Internet.

One of the programs that may be stored in the storage/memory 904 is a specific program 906. The specific program 906 may interact with an accessing entity to fetch and/or subscribe to information from the shared data. For example, the specific program 906 may be the runtime system that uses various primitives for interacting and controlling the processing entities. The program 906 and associated features may be implemented in software and/or firmware operable by way of the processor 902. The program storage/memory 904 may also be used to store data 908, such as data associated with the present exemplary embodiments. In one exemplary embodiment, the programs 906 and data 908 are stored in non-volatile electrically-erasable, programmable ROM (EEPROM), flash ROM, etc. so that the information is not lost upon power down of the system 900.

The processor 902 may also be coupled to user interface 910 elements associated with the system. The user interface 910 of the system 900 may include, for example, a display 912 such as a liquid crystal display, a keypad 914, speaker 916, and a microphone 918. These and other user interface components are coupled to the processor 902 as is known in the art. The keypad 914 may include alpha-numeric keys for performing a variety of functions, including executing operations assigned to one or more keys. Alternatively, other user interface mechanisms may be employed, such as voice commands, switches, touch pad/screen, graphical user interface using a pointing device, trackball, joystick, or any other user interface mechanism.

The system 900 may also include a digital signal processor (DSP) 920. The DSP 920 may perform a variety of functions, including analog-to-digital (A/D) conversion, digital-to-analog (D/A) conversion, speech coding/decoding, encryption/decryption, error detection and correction, bit stream translation, filtering, etc. The transceiver 922, generally coupled to an antenna 924, may transmit and receive the radio signals associated with a wireless device.

The system 900 of FIG. 9 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 906 and associated features, and data 908, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

The disclosed exemplary embodiments provide a chip multi-processor system, a method and a computer program product for sharing data in a safe way in the system. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in system, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for providing transparent access to shared data (16) in a chip multi-processor system (900), without using locks or transactional memory constructs, wherein a first set of processing entities (12) communicate with a second set of processing entities (14) via a task queue (20) for executing a code that necessitates access to the shared data (16), the method comprising:
receiving at the second set of processing entities (14) a task (21) from the task queue (20), the task (21) including a request from the first set of processing entities (12) for accessing the shared data (16);
establishing a communication link (15) between the second set of processing entities (14) and the shared data (16) such that requests for accessing the shared data (16) from the first set of processing entities (12) are routed through the communication link (15) to the shared data (16);
transparently migrating the execution of the code from the first set of processing entities (12) to at least one processing entity (14) of the second set of processing entities (14), to execute the task (21) by accessing the shared data (16) via the communication link (15); and
sending a completion message from the at least one processing entity (14) of the second set of processing entities (14) to the first set of processing entities (12) indicating a status of the executed task.

2. The method of claim 1, further comprising:
configuring the second set of processing entities to entirely own the shared data such that no other processing entity can access a portion of the shared data without the second set of processing entities.

3. The method of claim 1, further comprising:
executing the code, after being migrated to the at least one processing entity of the second set of processing entities, locally at the at least one processing entity that owns part of the shared data.

4. The method of claim 1, further comprising:
performing the migration of the execution of the code from the first set of processing entities to the at least one processing entity of the second set of processing entities without changing the code.

5. The method of claim 3, further comprising:
marking a section of the code that requires access to the shared data.

6. The method of claim 1, wherein the receiving step comprises:
selecting the task based on a value of a priority indicator included in the task.

7. The method of claim 1, further comprising:
executing a user application on the first set of processing entities to generate the task.

8. The method of claim 7, wherein the user application includes a critical section that requires access to the shared data.

9. The method of claim 8, further comprising:
executing the critical section in a same thread context in the at least one processing entity of the second set of processing entities as the first set of processing entity executes the critical section.

10. The method of claim 8, further comprising:
halting an execution of the user application if a blocking indicator is present in the critical section.

11. The method of claim 1, wherein the task includes a critical section of the code that necessitates the access to the shared data.

12. The method of claim 1, further comprising:
establishing direct communication links between each processing entity of the second set of processing entities and corresponding shared data areas of the shared data such that only the second set of processing entities own and have access to the shared data.

13. The method of claim 12, further comprising:
selecting the at least one processing entity of the second set of processing entities to execute the task based on (i) information stored in the task and (ii) a selected direct communication link between the at least one processing entity and the corresponding shared data area.

14. The method of claim 1, further comprising:
providing one or more processing entities of the second set of processing entities for each group of critical sections, wherein the critical section is a code that needs access to the shared data and the group of critical sections includes two or more critical sections that share a same shared data area of the shared data.

15. A chip multi-processor system (900) for providing access of a first set of processing entities (12) to shared data (16) without using locks or transactional memory constructs, the system comprising:
a second set of processing entities (14) configured to receive a task (21) from a task queue (20), the task (21) including a request from the first set of processing entities (12) for accessing the shared data (16);
the shared data (16) being connected via a communication link (15) to the second set of processing entities (14) such that requests for accessing the shared data (16) from a code executed on the first set of processing entities (12) are routed through the communication link (15) to the shared data (16); and
at least one processing entity (14) of the second set of processing entities (14) being configured to execute a part of the code from the first set of processing entities (12) to access the shared data (16) via the communication link (15) such that the execution of the code transparently migrates from the first set of processing entities (12) to the at least one processing entity (14), and to send a completion message to the first set of processing entities (12) indicating a status of the executed task.

16. The system of claim 15, wherein the second set of processing entities are configured to entirely own the shared data such that no other processing entity can access a portion of the shared data without the second set of processing entities.

17. The system of claim 15, wherein the at least one processing entity of the second set of processing entities is configured to execute the migrated code locally and the at least one processing entity is configured to own part of the shared data.

18. The system of claim 15, wherein the migration of the execution of the code from the first set of processing entities to the at least one processing entity of the second set of processing entities is performed without changing the code.

19. The system of claim 15, wherein the at least one processing entity is configured to select the task based on a value of a priority indicator included in the task.

20. The system of claim 15, wherein the first set of processing entities is executing a user application to generate the task.

21. The system of claim 20, wherein the user application includes a critical section that requires access to the shared data.

22. The system of claim 21, wherein the critical section is executed in a same thread context in the at least one processing entity of the second set of processors as the first set of processing entities executes the critical section.

23. The system of claim 15, further comprising:
direct communication links between each processing entity of the second set of processing entities and corresponding shared data areas of the shared data.

24. The system of claim 15, wherein the second set of processing entities, that own the shared data, are configured to receive the task based only on hardware constructs, which exclude locks and transactional memory constructs.

25. The system of claim 15, wherein the second set of processing entities are configured to establish direct communication links between each processing entity of the second set of processing entities and corresponding shared data areas of the shared data such that only the second set of processing entities own and have access to the shared data.

26. The system of claim 15, wherein one or more processing entities of the second set of processing entities is provided for each group of critical sections, wherein a critical section is a portion of the code that needs access to the shared data and the group of critical sections includes two or more critical sections that share a same shared data area of the shared data.

27. The system of claim 15, further comprising:
the first set of processing entities.

28. The system of claim 27, further comprising:
the task queue.

29. A computer readable medium including computer executable instructions, wherein the instructions, when executed by a chip multi-processor system (900), cause the chip multi-processor system (900) to access shared data (16), without using locks or transactional memory constructs, wherein a first set of processing entities (12) communicate with a second set of processing entities (14) via a task queue (20) for executing a code that necessitates accessing the shared data (16), the instructions comprising:
receiving at the second set of processing entities (14) a task (21) from the task queue (20), the task (21) including a request from the first set of processing entities (12) for accessing the shared data (16);
establishing a communication link (15) between the second set of processing entities (14) and the shared data (16) such that requests for accessing the shared data (16) from the first set of processing entities (12) are routed through the communication link (12) to the shared data (16);
transparently migrating the execution of the code from the first set of processing entities (12) to at least one processing entity (14) of the second set of processing entities (14), to execute the task (21) by accessing the shared data (16) via the communication link (15); and
sending a completion message from the at least one processing entity (14) of the second set of processing entities (14) to the first set of processing entities (12) indicating a status of the executed task.

30. A method for facilitating safe access to shared data (16) in a chip multi-processor system (900), wherein a first set of processing entities (12) communicate with a second set of processing entities (14) via a task queue (20) for accessing the shared data (16), which is owned by the second set of processing entities (14), the communication being assisted by a runtime system (906), the method comprising:
invoking a first primitive of the runtime system (906) when access to at least one shared data area (16) of the shared data (16) is requested by at least one first processing entity (12) of the first set of processing entities (12), the at least one first processing entity (12) executing a code that includes a critical section (22) that necessitates the access to the shared data area (16);
blocking an activity of the at least one first processing entity (12), when an indicator is detected by the first primitive in the request, until the access to the shared data area (16) is completed;
selecting from the second set of processing entities (14) at least one second processing entity (14) via a second primitive of the runtime system (906);
dispatching via a third primitive the request to the at least one second processing entity (14) of the second set of processing entities (14) while the code is executed on the at least one first processing entity (12); and
suspending, by a forth primitive of the runtime system (906), the execution of the code on the at least one first processing entity (12) when a result of the execution of the critical section (22) is needed by the code.

31. The method of claim 30, further comprising:
executing in parallel the code on the at least one first processing entity and the critical section of the code on the at least one second processing entity that owns part of the shared data.

32. The method of claim 30, further comprising:
providing a hardware mechanism that includes generating at least one processor instruction that automatically dispatches the task to the second set of processing entities.

33. The method of claim 32, further comprising:
transferring a thread context from the first set of processing entities to the second set of processing entities based on the hardware mechanism.
